(19) United States
(12) Patent Application Publication
(10) Pub. No.: US 2025/0192427 A1
(43) Pub. Date: Jun. 12, 2025

(54) COMMUNICATION LINE

(71) Applicant: UNIQCONN INC., Seongnam-si (KR)

(72) Inventors: Young Dong KIM, Hwaseong-si (KR); Yong Hun OH, Pyeongtaek-si (KR); Joung Min PARK, Osan-si (KR); Jin Seok KIM, Seongnam-si (KR)

(73) Assignee: UNIQCONN INC., Seongnam-si (KR)

(21) Appl. No.: 18/928,988

(22) Filed: Oct. 28, 2024

(30) Foreign Application Priority Data
Dec. 11, 2023 (KR) 10-2023-0178232

(51) Int. Cl. H01Q 1/52; H01Q 13/08

(52) U.S. Cl. CPC H01Q 1/526; H01Q 13/085

(57) ABSTRACT

The present disclosure relates to a communication line. The communication line according to an embodiment of the present disclosure includes a shielding portion that has a hollow pipe shape and extends in a longitudinal direction, at least one transmission unit that is disposed inside the shielding portion and transmits a signal from one end thereof to the other end, and a signal adjustment unit that is disposed inside the shielding portion and adjusts the signal received from the transmission unit.

### CROSS-REFERENCE TO RELATED APPLICATION

This application claims priority to and the benefit of Korean Patent Application No. 10-2023-0178232, filed on Dec. 11, 2023, the disclosure of which is incorporated herein by reference in its entirety.

### BACKGROUND

### 1. Field of the Invention

The present disclosure relates to a communication line, and more particularly, to a communication line for signal transmission.

### 2. Discussion of Related Art

Communication lines made of dielectrics have a lower manufacturing cost than conductor-based communication lines have and their installation and management are easier than those of optical-based communication lines, and accordingly, utilizing the communication lines may be efficiently utilized in chip-to-chip communications.

Meanwhile, as a communication line is getting longer, the intensity of a signal transmitted inside the communication line may become weaker, or the intensity of noise included in the signal may increase. Accordingly, conventional communication lines have a problem in that as the length increases, signal loss or the intensity of noise increases.

Further, the conventional communication lines only transmit signals emitted from one side of a board to the other side of the board without change, and thus there is a problem in that change or control of the signals depends on other electrical parts of the board. Further, the conventional communication lines have a problem in that the conventional communication lines cannot output or receive various signals, and boards to which the conventional communication lines can be connected are limited.

Further, the conventional communication lines have a problem in that the conventional communication lines are difficult to be installed in a narrow or complex space because excessive force is required to bend the conventional communication lines.

Meanwhile, the related art described above is technical information that the inventor possessed for deriving the present disclosure or acquired during the process of deriving the present disclosure, and cannot necessarily be considered as publicly known technology disclosed to the general public prior to the application of the present disclosure.

### RELATED ART DOCUMENT

### Patent Document

(Patent Document 1) Korean Laid-open Patent Publication No. 10-2010-0032769 (Mar. 26, 2010)

### SUMMARY OF THE INVENTION

The present disclosure is directed to providing a communication line capable of preventing signal loss or noise intensity from increasing even when its length increases.

The present disclosure is also directed to providing a communication line capable of changing or controlling a signal transmitted inside the communication line.

The present disclosure is also directed to providing a communication line capable of outputting or receiving various signals and being connected to various boards.

The present disclosure is also directed to providing a communication line which is capable of being easily assembled and in which parts used for assembly can be changed in various ways.

The present disclosure is also directed to providing a communication line capable of being easily bent, and easily connecting devices to each other even in a narrow or complex space.

Objects of the present disclosure are not limited to the above-described object and other objects that are not described may be clearly understood by those skilled in the art from the following descriptions.

According to an aspect of the present disclosure, there is provided a communication line which includes a shielding portion that has a hollow pipe shape and extends in a longitudinal direction, at least one transmission unit that is disposed inside the shielding portion and transmits a signal from one end thereof to the other end, and a signal adjustment unit that is disposed inside the shielding portion and adjusts the signal received from the transmission unit.

The transmission unit may include a core portion that extends in the longitudinal direction to transmit an electromagnetic wave signal received at the one end to the other end through a dielectric material.

The transmission unit may include a first transmission unit and a second transmission unit, and the signal adjustment unit may be disposed between the first transmission unit and the second transmission unit and adjust a signal received from the first transmission unit and transmit the adjusted signal to the second transmission unit.

The signal adjustment unit may include at least one of an amplifier that amplifies the received signal, a filter that removes noise from the received signal, and a frequency converter that changes a frequency of the received signal.

The signal adjustment unit may further include a circuit board, and at least one of the amplifier, the filter, and the frequency converter may be mounted on the circuit board.

The signal adjustment unit may further include a guide unit that forms a space in which a signal is guided, the space formed by the guide unit may have a shape recessed in a longitudinal direction of the signal adjustment unit from one side of the signal adjustment unit, and a cross-section of the guide unit in a direction perpendicular to the longitudinal direction of the signal adjustment unit has a circular shape.

In order for the space formed by the guide unit to have a frustum shape, a cross-sectional area of the guide unit in the direction perpendicular to the longitudinal direction may increase as the guide unit approaches the transmission unit, and at least a portion of the guide unit may formed of a conductor to reflect signals.

The guide unit may include at least one step portion, a cross-sectional area of each of portions of the guide unit separated by the step portion unit in the direction perpendicular to the longitudinal direction of the signal adjustment may be constant, and among the portions of the guide unit separated by the step portion, a cross-sectional area of a portion closer to the transmission unit may be greater than a cross-sectional area of a portion farther from the transmission unit.

The signal adjustment unit may include at least one horn antenna which converts a signal received from the transmission unit into an electrical signal or emits an adjusted signal toward the transmission unit and which is disposed on the guide unit.

The signal adjustment unit may include at least one Vivaldi antenna which converts a signal received from the transmission unit into an electrical signal or emits an adjusted signal toward the transmission unit and which is disposed on the circuit board.

The transmission unit may be inserted into the shielding portion in the longitudinal direction and disposed in the shielding portion, and one side end surfaces of the transmission unit and the signal adjustment unit may face each other.

The transmission unit may include at least one rib formed to extend from an outer surface of the core portion, at least one rib fixing unit formed to extend in the longitudinal direction of the shielding portion may be formed on an inner surface of the shielding portion, and the transmission unit may be disposed while being slid so that the rib corresponds to the rib fixing unit.

The rib fixing unit may include a first fixing portion and a second fixing portion that are formed to extend in the longitudinal direction of the shielding portion and to protrude from the inner surface of the shielding portion, and the rib may be disposed in a space between the first fixing portion and the second fixing portion.

The communication line may further include at least one conductor portion configured to transmit a signal different from the signal transmitted from the transmission unit, wherein at least a portion of the conductor portion may be disposed between the first fixing portion and the second fixing portion and between a distal end portion of the rib and the inner surface of the shielding portion.

An end portion of the conductor portion may be connected to the signal adjustment unit, and the conductor portion may include at least one of a conductor portion that transmits or receives a signal to or from the signal adjustment unit, and a conductor portion that supplies power to the signal adjustment unit.

The rib may include a first rib and a second rib that are formed to be spaced apart from each other in a longitudinal direction of the core portion on the outer surface of the core portion.

An insertion groove having a shape corresponding to a shape of the one side end surface of the transmission unit may be formed in an end surface of the signal adjustment unit, and one end of the transmission unit may be fitted into the insertion groove.

The core portion may have a hollow pipe shape, an insertion protrusion that protrudes to correspond to a shape of a hole inside the core portion may be formed in the end surface of the signal adjustment unit, and the insertion protrusion may be inserted into the hole inside the core portion.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is an exploded perspective view of a communication line according to an embodiment of the present disclosure;

FIG. 2 is a cross-sectional view of the communication line in a direction perpendicular to a longitudinal direction according to an embodiment of the present disclosure;

FIG. 3 is an exploded perspective view of a communication line in which a conductor portion is disposed according to another embodiment of the present disclosure;

FIG. 4 is a cross-sectional view of the communication line in a direction perpendicular to a longitudinal direction according to another embodiment of the present disclosure;

FIG. 5 is a view for describing a communication line in which two transmission units and a signal adjustment unit are coupled according to still another embodiment of the present disclosure;

FIG. 6 is a cross-sectional view of a state in which a transmission unit is coupled to one side of a signal adjustment unit including a guide unit forming a space having a frustum shape according to yet another embodiment of the present disclosure;

FIG. 7 is a cross-sectional view of a state in which a transmission unit is coupled to one side of a signal adjustment unit in which a Vivaldi antenna is disposed according to yet another embodiment of the present disclosure;

FIG. 8 is a cross-sectional view of a state in which a transmission unit is coupled to one side of a signal adjustment unit in which a horn antenna is disposed according to yet another embodiment of the present disclosure;

FIG. 9 is a cross-sectional view of a state in which a transmission unit is coupled to one side of a signal adjustment unit connected to a conductor portion according to yet another embodiment of the present disclosure; and

FIG. 10 is a view for describing a communication system using a communication line according to an embodiment of the present disclosure.

### DETAILED DESCRIPTION OF EXEMPLARY EMBODIMENTS

Advantages and features of the present disclosure and methods of achieving the same will be clearly understood with reference to the accompanying drawings and embodiments described in detail below. However, the present disclosure is not limited to the embodiments disclosed below, but may be implemented in various different forms. The embodiments are provided in order to fully explain the present disclosure and fully explain the scope of the present disclosure for those skilled in the art. That is, the scope of the present embodiments is only defined by the appended claims.

The shapes, sizes, ratios, angles, or numbers disclosed in the drawings for describing the embodiments of the present disclosure are exemplary, and therefore, the present disclosure is not limited to the matters illustrated. Further, in description of the present disclosure, when it is determined that detailed descriptions of related well-known functions or configurations may unnecessarily obscure the gist of the present disclosure, detailed descriptions thereof will be omitted. Further, when the terms “include,” “have,” “consist of,” etc., are used in this specification, another portion may be added unless “only” is used. When a component is expressed in the singular form, it includes a case where it includes a plural form unless the context clearly indicates otherwise.

In interpretation of components, it is interpreted as including a range of errors even when there is no separate explicit description. For example, unless otherwise explicitly stated, the term “same” does not mean exactly the same, but rather “substantially the same” within a range of error that those skilled in the art may reasonably expect to encounter in practicing the present disclosure.

It should be understood that, although the terms “first,” “second,” etc., may be used herein to describe various components, these components are not limited by these terms. The terms are only used to distinguish one component from another component. Therefore, it should be understood that a first component to be described below may be a second component within the technical scope of the present disclosure.

Unless otherwise specified, like reference numerals refer to like elements throughout the specification.

The individual features of the various embodiments of the present disclosure may be partially or wholly combined or combined with each other, and as can be fully understood by those skilled in the art, various technical connections and operations are possible, and each embodiment may be implemented independently of each other or may be implemented together in a related relationship.

In the present disclosure, when a plurality of components are connected, it should be understood that the respective components may be connected not only directly to each other, but also indirectly. Therefore, when the plurality of components are connected to each other, another component may be connected between the plurality of components.

In description of various embodiments of the present disclosure, when some configuration of an embodiment is substantially the same as or corresponding to some configuration of another embodiment described above, the description of that configuration may be omitted for a clear and concise description of the present disclosure. Further, when some configurations have a structure that is symmetrical with other configurations, for example, a structure with axial symmetry or rotational symmetry, so that both configurations are substantially the same configuration with only a difference in direction or location, the description of the configuration may be omitted for the sake of a clear and concise description of the present disclosure, unless it is necessary to specify the present disclosure.

Hereinafter, the present disclosure will be described in detail with reference to the accompanying drawings.

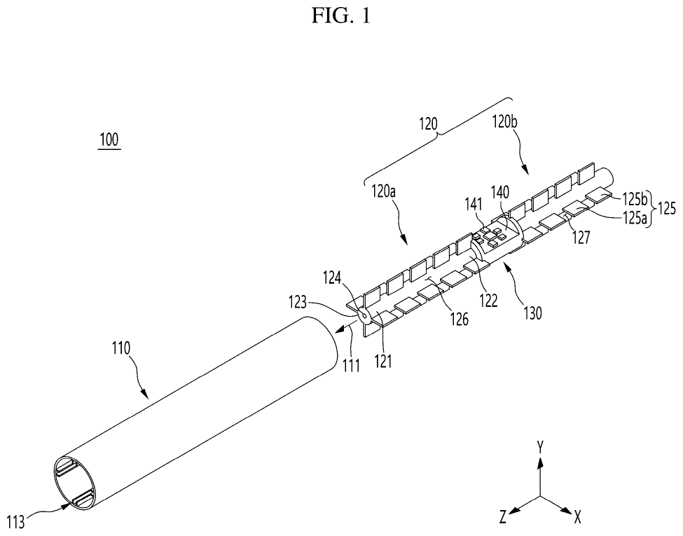

FIG. 1 is an exploded perspective view of a communication line according to an embodiment of the present disclosure. In FIG. 1, although a transmission unit 120 and a signal adjustment unit 130 are illustrated as being spaced apart from a shielding portion 110, this is a state in which a communication line 100 is disassembled for clear description, and the transmission unit 120 and the signal adjustment unit 130 are disposed inside the shielding portion 110 in the communication line 100.

First, referring to FIG. 1, the communication line 100 includes a shielding portion 110 that has a hollow pipe shape and extends in a longitudinal direction 111, at least one transmission unit 120 that is disposed inside the shielding portion 110 and transmits a signal from one end 121 thereof to the other end 122, and a signal adjustment unit 130 that is disposed inside the shielding portion 110 and adjusts the signal received from the transmission unit 120.

According to the above-described embodiment, the transmission unit 120 and the signal adjustment unit 130 are located inside the shielding portion 110, and thus may be protected by the shielding portion 110. For example, the shielding portion 110 may prevent an impact from the outside of the communication line 100 from being transmitted to the transmission unit 120, or may prevent dust or foreign matter from the outside of the communication line 100 from being attached to the transmission unit 120. Accordingly, the shielding portion 110 may prevent the quality of the signal transmitted from the transmission unit 120 from being degraded.

Further, the transmission unit 120 may transmit a signal, and the signal adjustment unit 130 may adjust the signal transmitted in this way. Therefore, the communication line 100 may change or control the signal transmitted inside the communication line 100.

The signal adjustment unit 130 according to the embodiment of the present disclosure may change or control a received signal in various ways. For example, the signal adjustment unit 130 may include at least one of an amplifier that amplifies the received signal and a filter that removes noise from the received signal. In this case, even when a length of the communication line 100 increases, signal loss or the intensity of noise may not increase. Further, the signal adjustment unit 130 may include a frequency converter that changes a frequency of the received signal. In this case, the communication line 100 may adjust signals so that a frequency of an input signal and a frequency of an output signal are different, and thus the communication line 100 may output or receive various signals. Accordingly, the communication line 100 may be connected to various boards. That is, since the communication line 100 can adjust signals by itself, the communication line 100 is not limited to an amplitude of the signal to be transmitted, a size of noise, or a frequency of the signal, that is, the characteristics of the signal, and may be connected to various electrical devices and used in various situations.

Meanwhile, referring to FIG. 1, the signal adjustment unit 130 may include a circuit board 140. For example, the circuit board 140 may be a printed circuit board (PCB). Further, the circuit board 140 may include one or more electronic parts 141. For example, the electronic part 141 may be one of an amplifier that amplifies a signal, a filter that removes noise from the signal, a frequency converter that changes a frequency of the signal, and an integrated circuit (IC).

Meanwhile, in FIG. 1, although the electronic parts 141 are illustrated as being disposed only on an upper surface of the circuit board 140, the electronic parts 141 may also be disposed on a lower surface or inside the circuit board 140. Meanwhile, the type and arrangement location of electronic parts 141, the form in which the electronic parts 141 are mounted (surface mounted) on a board, and a connection relationship between the electronic parts 141 are not limited thereto.

Meanwhile, according to the embodiment of the present disclosure, the transmission unit 120 may perform bidirectional signal transmission. For example, referring to FIG. 1, the transmission unit 120 may not only transmit a signal from one end 121 to the other end 122, but may also transmit a signal from the other end 122 to the one end 121. Accordingly, the communication line 100 may perform bidirectional signal transmission.

Further, according to the embodiment of the present disclosure, the signal received at the one end 121 of the transmission unit 120 may be an electromagnetic wave signal. For example, the signal received at the one end 121 of the transmission unit 120 may be an electromagnetic wave signal emitted from a board (not illustrated) or a transmitter 990.

Meanwhile, referring to FIG. 1, the transmission unit 120 may include a core portion 123 that extends in the longitudinal direction 111 to transmit the electromagnetic wave signal received at the one end 121 to the other end 122 through a dielectric material. Further, the transmission unit 120 may include one or more ribs 125 formed to extend from an outer surface of the core portion 123. In the embodiment of the present disclosure, the rib 125 may extend to an inner surface of the shielding portion 110 so that the shielding portion 110 and the transmission unit 120 may support each other when the shielding portion 110 and the transmission unit 120 are coupled.

According to the embodiment of the present disclosure, the core portion 123 may be made of a dielectric material. For example, the core portion 123 may be made of a dielectric material having a higher permittivity than the air has. In the present disclosure, the dielectric material may be a material having permittivity. The permittivity is a value for the effect of a medium between charges on an electric field when the electric field acts between the charges, and depends on the frequency of an electromagnetic wave signal propagating in a dielectric. Further, when an electromagnetic wave signal propagates toward a boundary between materials having different permittivity, the electromagnetic wave signal may be adjusted to be totally reflected at the boundary between the two materials by adjusting permittivity of each of the two materials, a signal incident angle, or a frequency of the signal. That is, the electromagnetic wave signal may propagate along a dielectric material.

Accordingly, due to the properties of the above-described dielectric, the electromagnetic wave signal may be transmitted in the longitudinal direction 111 of the core portion 123 through the dielectric material.

Meanwhile, in the communication line 100 according to the embodiment of the present disclosure, the shielding portion 110 and the transmission unit 120 may be formed to extend in the same direction. Accordingly, the shielding portion 110 and the transmission unit 120 may be manufactured by an injection molding process, and thus the manufacturing time and cost can be reduced.

Meanwhile, in the communication line 100 according to the embodiment of the present disclosure, the shielding portion 110 and the transmission unit 120 may be made of the same dielectric material. In this case, since the permittivities of the shielding portion 110 and the transmission unit 120 are the same, the frequency of the transmitted signal may be easily adjusted in order to prevent the signal transmitted through the core portion 123 from leaking to the outside. In this case, not only the board (not illustrated) or an electric device connected to the communication line 100, but also the signal adjustment unit 130 disposed inside the communication line 100 may adjust the frequency of the transmitted signal.

Further, in the communication line 100 according to the embodiment of the present disclosure, the shielding portion 110 and the transmission unit 120 may be made of a flexible material. In this case, the communication line 100 may be easily bent, and may be changed to have various shapes to connect chips and chips even in a narrow space.

Meanwhile, referring to FIG. 1, a cross-section of the core portion 123 in the longitudinal direction may have a circular shape. Further, a central hole 124 may be formed inside the core portion 123. For example, the central hole 124 may extend in a longitudinal direction of the core portion 123 while having a circular shape. Furthermore, as illustrated in FIG. 1, the core portion 123 and the central hole 124 may share a central axis. However, the shapes and locations of the core portion 123 and the central hole 124 are not limited thereto. For example, a cross-section of the central hole 124 in a direction perpendicular to the longitudinal direction may have a polygonal shape and may be formed at a location outside the central axis of the core portion 123. When the central hole 124 is formed in the core portion 123, the force exerted to bend the core portion 123 may be reduced. Accordingly, since the communication line 100 is easily bent, the communication line 100 may be installed in various forms even in a narrow or complex space.

Meanwhile, the ribs 125 according to the embodiment of the present disclosure may be formed in a straight line in a radial direction of the core portion 123, as illustrated in FIG. 1. Here, the radial direction of the core portion 123 may be a direction radially outward from the center of the core portion 123. Meanwhile, when the electromagnetic wave signal propagates, an electromagnetic field oscillates in a plane perpendicular to a direction of propagation of the electromagnetic wave. For example, when the electromagnetic wave signal propagates, horizontally polarized waves and vertically polarized waves may be generated. Accordingly, when the rib 125 extends in a straight line in the radial direction of the core portion 123 and the extension direction of the rib 125 is misaligned with the polarization direction of the electromagnetic wave signal radiated from the transmitter 990, a phenomenon of the electromagnetic field being emitted to the outside from the communication line 100 may be alleviated. That is, since the polarization direction of the electromagnetic field generated from the electromagnetic wave signal transmitted through the core portion 123 is different from the extension direction of the rib 125, the electromagnetic field leaking to the outside along the rib 125 may be reduced.

Meanwhile, the rib 125 according to the embodiment of the present disclosure may be provided as a plurality of ribs 125. For example, referring to FIG. 1, the number of ribs 125 may be four. When the rib 125 is provided as a plurality of ribs 125 in this way, the shielding portion 110 and the transmission unit 120 are more firmly sustained, and thus the durability of the communication line 100 against external impact can be improved. However, the number of ribs 125 is not limited. For example, the number of ribs 125 may be two or one.

Further, according to the embodiment of the present disclosure, the plurality of ribs 125 may be disposed at equal intervals or angles. For example, referring to FIG. 1, the four ribs 125 may be disposed at equal intervals, each forming 90°. In this way, when the ribs 125 are disposed at equal intervals or angles, the communication line 100 may be more easily bent. For example, referring to FIG. 1, the communication line 100 may be easily bent in four directions forming 45° in an X-Y plane, that is, an X-shaped direction. Further, when the ribs 125 are disposed at equal intervals or angles, the communication line 100 may have a rotational symmetry shape, and thus may be structurally stable and easy to install in a communication system.

Meanwhile, referring to FIG. 1, a space 126 between the ribs 125 may be filled with the air. Accordingly, as described above, when the core portion 123 is made of a dielectric material having a higher permittivity than the air has, the electromagnetic wave signal received at the one end 121 of the core portion 123 may be totally reflected inside the core portion 123 and may not leak through the space 126 outside the core portion 123 when the electromagnetic wave signal received at the one end 121 of the core portion 123 is transmitted to the other end 122. Accordingly, the communication line 100 may transmit the electromagnetic wave signal with a low loss rate.

Meanwhile, referring to FIG. 1, the ribs 125 may include a first rib 125a and a second rib 125b that are formed on the outer surface of the core portion 123 to be spaced apart from each other in the longitudinal direction 111 of the core portion 123. For example, the communication line 100 includes four ribs, and one of the ribs 125 may be composed of a plurality of small ribs including the first rib 125a and the second rib 125b. Further, a space 127 may be formed between the first rib 125a and the second rib 125b.

According to the above-described embodiment, since the rib 125 can be composed of a plurality of small ribs 125a and 125b spaced apart from each other, the transmission unit 120 may be easily bent in all directions. Further, as described above, the electromagnetic wave signal transmitted through the core portion 123 may be emitted along the dielectric material of the rib 125. According to the above-described embodiment, since the volume of the rib 125 in the communication line 100 is reduced, the electromagnetic field emitted to the outside from the communication line 100 may be reduced.

Meanwhile, according to the embodiment of the present disclosure, the transmission unit 120 may be provided as a plurality of transmission units 120. For example, as illustrated in FIG. 1, the transmission units 120 may include a first transmission unit 120a and a second transmission unit 120b. Further, the signal adjustment unit 130 may be disposed between the first transmission unit 120a and the second transmission unit 120b. In this case, the signal adjustment unit 130 may adjust a signal received from the first transmission unit 120a and transmit the adjusted signal to the second transmission unit 120b.

As described above, the transmission unit 120 may transmit signals in both directions, that is, from the one end 121 to the other end 122 or from the other end 122 to the one end 121. Therefore, the signal adjustment unit 130 may adjust a signal received from the first transmission unit 120a and transmit the adjusted signal to the second transmission unit 120b or may adjust a signal received from the second transmission unit 120b and transmit the adjusted signal to the first transmission unit 120a.

According to the embodiment of the present disclosure, the signal adjustment unit 130 may convert an electromagnetic wave signal received from the transmission unit 120 into an electrical signal, adjust the converted electrical signal, convert the adjusted electrical signal back into an electromagnetic wave signal, and emit and transmit the converted electromagnetic wave signal to the second transmission unit 120b. However, the form of the signal adjusted by the signal adjustment unit 130 is not limited. For example, the signal adjustment unit 130 may adjust the electromagnetic wave signal transmitted from the transmission unit 120 without a conversion process, and emit the adjusted electromagnetic wave signal to the second transmission unit 120b.

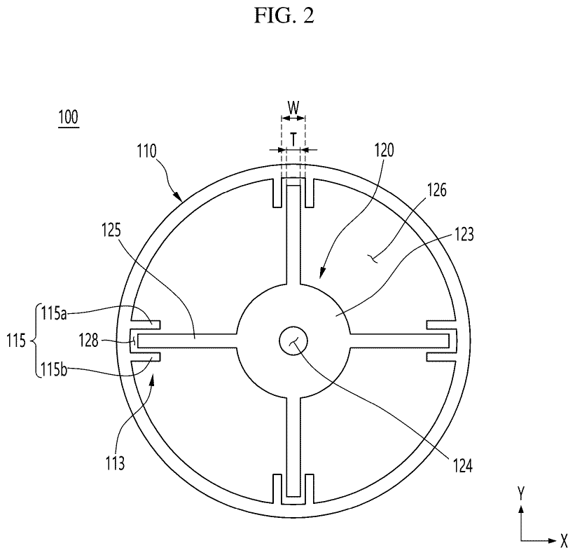

Meanwhile, referring to FIG. 1, the transmission unit 120 may be inserted into the shielding portion 110 in the longitudinal direction 111 and disposed in the shielding portion 110. For example, the transmission unit 120 may be disposed while being slid in the longitudinal direction 111 of the shielding portion 110. According to the above-described embodiment, the shielding portion 110, the transmission unit 120, and the signal adjustment unit 130 are each detachable, and thus the respective parts constituting the communication line 100 may be manufactured separately. Accordingly, the communication line 100 may be easily manufactured and managed. Further, since the shapes of the respective parts constituting the communication line 100 may be changed in various ways and assembled, the communication line 100 may be easily changed in various ways depending on a space in which the communication line 100 is disposed. Meanwhile, the insertion and coupling of the shielding portion 110 and the transmission unit 120 will be described with reference to FIG. 2.

FIG. 2 is a cross-sectional view of the communication line in the direction perpendicular to the longitudinal direction according to an embodiment of the present disclosure.

Referring to FIGS. 1 and 2, one or more rib fixing units 113 formed to extend in the longitudinal direction 111 of the shielding portion 110 may be formed on the inner surface of the shielding portion 110. The rib fixing unit 113 may be formed to correspond to the rib 125, and thus the transmission unit 120 may be slid into an inside of the shielding portion 110. Therefore, the number, locations, or shape of the rib fixing units 113 may be determined to correspond to the number, locations, or shape of the ribs 125. For example, as illustrated in FIGS. 1 and 2, the rib 125 and the rib fixing unit 113 may be provided as four ribs 125 and four rib fixing units 113 formed at equal intervals and angles, respectively.

According to the above-described embodiment, since the transmission unit 120 is slid into the inside of the shielding portion 110, the components constituting the communication line 100 are not subject to excessive force during the assembly process, and thus the lifetime of the components constituting the communication line 100 can be increased.

According to the embodiment of the present disclosure, the rib fixing unit 113 may include fixing portions 115 formed to protrude therefrom. For example, as disclosed in FIG. 2, the rib fixing unit 113 may include a first fixing portion 115a and a second fixing portion 115b that are formed to extend in the longitudinal direction 111 of the shielding portion 110 and to protrude from the inner surface of the shielding portion 110. Further, the rib 125 may be disposed in a space 128 between the first fixing portion 115a and the second fixing portion 115b. Here, a thickness T of the rib 125 may be smaller than an interval W between the first fixing portion 115a and the second fixing portion 115b.

According to the above-described embodiment, the transmission unit 120 may be disposed outside the shielding portion 110 so that the rib 125 is located between the first fixing portion 115a and the second fixing portion 115b, and then slid in the longitudinal direction 111 and coupled to the shielding portion 110. Accordingly, the communication line 100 may be more simply assembled.

Meanwhile, in the communication system, various signals may need to be transmitted. For example, in the communication system, in addition to data signals, which are high-frequency electromagnetic wave signals, a supply of power (source), ground, etc., may be required, and transmission of low-speed or low-frequency signals, such as on-off signals, may be required.

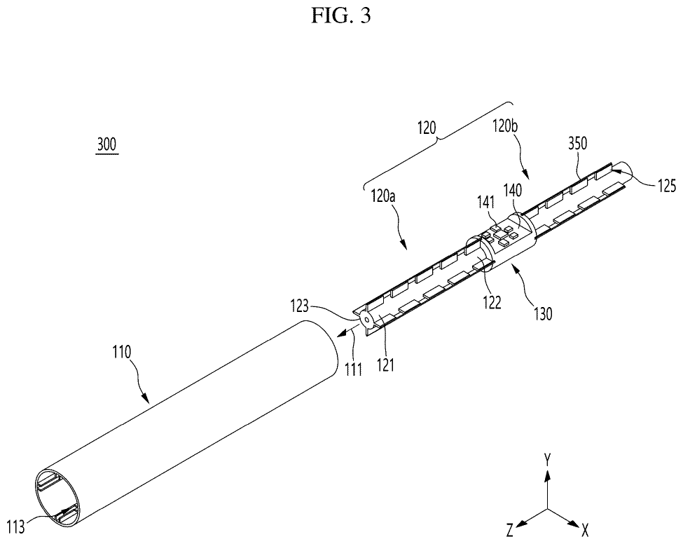

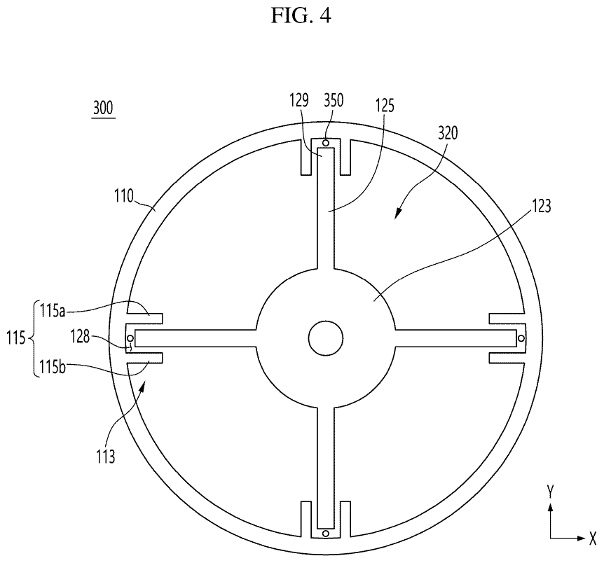

According to the embodiment of the present disclosure, by placing a conductor portion 350 on a communication line 300, the above-described problem may be solved. This will be described with reference to FIGS. 3 and 4.

FIG. 3 is an exploded perspective view of a communication line in which a conductor portion is disposed according to another embodiment of the present disclosure. FIG. 4 is a cross-sectional view of the communication line in a direction perpendicular to a longitudinal direction according to another embodiment of the present disclosure.

According to the embodiment of the present disclosure, the communication line 300 may include the conductor portion 350 that transmits a signal. For example, the conductor portion 350 may transmit a signal different from a signal transmitted from a transmission unit 120. More specifically, for example, the signal transmitted from the transmission unit 120 may be a high-frequency electromagnetic wave signal for transmitting or receiving data, and the signal transmitted from the conductor portion 350 may be a low-speed or low-frequency signal or a power signal. When the conductor portion 350 transmits a power signal, the conductor portion 350 may supply power and ground.

Further, as illustrated in FIGS. 3 and 4, the conductor portion 350 may be provided as a plurality of conductor portions 350. In this case, since the signal transmitted from the conductor portion 350 may also include a plurality of signals, the communication line 300 may simultaneously transmit various signals in addition to data signals. However, the number of conductor portions 350 is not limited. For example, the number of conductor portions 350 disposed in the communication line 300 may be one.

Meanwhile, according to the embodiment of the present disclosure, the conductor portions 350 may be disposed inside a shielding portion 110. For example, as disclosed in FIG. 3, the conductor portion 350 may be disposed adjacent to a distal end portion 129 of a rib 125, and then inserted together with the transmission unit 120 when the transmission unit 120 is inserted into the shielding portion 110. At least a portion of the conductor portion 350 inserted in this way may be disposed in a space 128 between a first fixing portion 115a and a second fixing portion 115b and between the distal end portion 129 of the rib 125 and an inner surface of the shielding portion 110, as illustrated in FIG. 4. According to the above-described embodiment, the conductor portion 350 may be slid and disposed in the shielding portion 110 together with the transmission unit 120, and thus the communication line 300 may be more easily assembled. Further, the conductor portion 350 may be fixed by a rib fixing unit 113, the distal end portion 129 of the rib 125, and the inner surface of the shielding portion 110, and thus may be fixed firmly.

Meanwhile, according to the embodiment of the present disclosure, the conductor portion 350 may include a wire (not illustrated) and a covering (not illustrated). In this case, the signal transmitted from the conductor portion 350 may not be emitted to the outside of the conductor portion 350 due to the covering, and may not be affected by the outside of the conductor portion 350. Accordingly, the communication line 300 may transmit a signal transmitted through a core portion 123 and the signal transmitted from the conductor portion 350, with high quality without mutual interference.

Meanwhile, according to the embodiment of the present disclosure, the conductor portion 350 may be connected to a signal adjustment unit 130 to transmit a signal or power between a board (not illustrated) and the signal adjustment unit 130. For example, the conductor portion 350 may be connected to a circuit board 140 to supply a signal or power for operating electronic parts 141 disposed on the circuit board 140. To this end, the conductor portion 350 may include at least one of a conductor portion that transmits or receives a signal to or from the signal adjustment unit 130 and a conductor portion that supplies power to the signal adjustment unit 130. Meanwhile, terminals for transmitting a signal to the conductor portion 350 or receiving a signal from the conductor portion 350 may be disposed on the board (not illustrated).

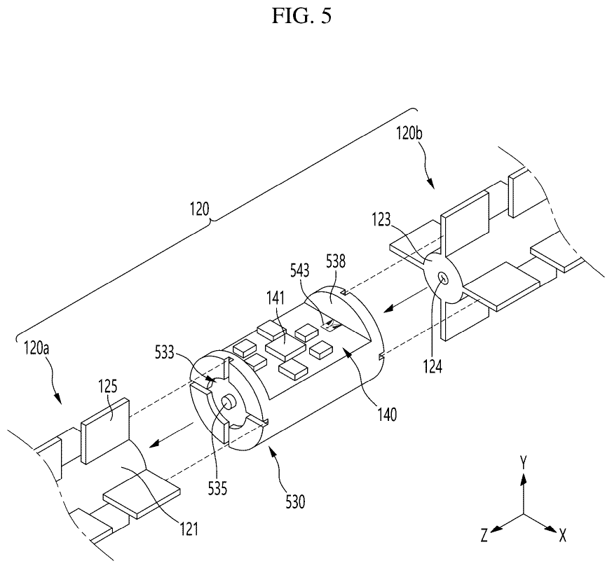

Meanwhile, according to the embodiment of the present disclosure, not only may the transmission unit 120 be coupled to the shielding portion 110 while the rib 125 is fixed by the rib fixing unit 113, but also the transmission unit 120 and a signal adjustment unit 530 may be coupled to each other so that their respective one side end surfaces face each other. This will be described with reference to FIG. 5.

FIG. 5 is a view for describing a communication line in which two transmission units and a signal adjustment unit are coupled according to still another embodiment of the present disclosure. In FIG. 5, although two transmission units 120a and 120b are illustrated as being coupled to the signal adjustment unit 530, the number of transmission units 120 is not limited thereto. For example, the signal adjustment unit 530 may be coupled to one transmission unit 120.

According to the embodiment of the present disclosure, one side end surfaces of the transmission unit 120 and the signal adjustment unit 530 may face each other. Further, an insertion groove 533 having a shape corresponding to the shape of the one side end surface of the transmission unit 120 may be formed in the end surface of the signal adjustment unit 530. Here, the shape of the insertion groove 533 is not limited, and may be determined by the shape of the one side end surface of the transmission unit 120. For example, as disclosed in FIG. 5, the transmission unit 120 may include a core portion 123 and four ribs 125, and the insertion groove 533 may be recessed to correspond to the shape of one end 121 of the transmission unit 120. Meanwhile, the signal adjustment unit 530 may be formed first, and then one end of the signal adjustment unit 530 may be recessed to form the insertion groove 533, or the signal adjustment unit 530 may be formed so that the insertion groove 533 is formed. In addition, the one end 121 of the transmission unit 120 may be fitted into the insertion groove 533.

Meanwhile, the core portion 123 may have a hollow pipe shape, and a central hole 124 illustrated in FIG. 5 may be formed inside the core portion 123 as described above. Further, an insertion protrusion 535 that protrudes to correspond to a shape of the central hole 124 inside the core portion 123 may be formed in the end surface of the signal adjustment unit 530. For example, when a cross-section of the central hole 124 in a direction perpendicular to a longitudinal direction has a circular shape, the insertion protrusion 535 corresponding thereto may have a cylindrical shape with a diameter slightly smaller than a diameter of the central hole 124. In addition, the insertion protrusion 535 may be inserted into the central hole 124 inside the core portion 123. That is, the transmission unit 120 and the signal adjustment unit 530 may be fixed when the insertion protrusion 535 is inserted into the central hole 124.

According to the above-described embodiment, since the one side end surface of the transmission unit 120 and the one side end surface of the signal adjustment unit 530 may face each other when the transmission unit 120 is inserted into the shielding portion 110 in the longitudinal direction 111 and disposed in the shielding portion 110, the communication line 100 may be easily assembled and, at the same time, have the signal transmission direction to be the same as the longitudinal direction 111.

Further, according to the above-described embodiment, the transmission unit 120 may be fixed by a rib fixing unit 113 and, at the same time, the one end 121 of the transmission unit 120 may be fitted into the insertion groove 533 or the insertion protrusion 535 may be inserted into the central hole 124 inside the core portion 123 so that the transmission unit 120 and the signal adjustment unit 530 may be coupled to be engaged with each other. Accordingly, the transmission unit 120 or the signal adjustment unit 530 may be prevented from rotating or moving inside the shielding portion 110. Therefore, the communication line may be easily assembled and, at the same time, the communication line may be structurally stable because parts of the communication line do not shake after assembled. Furthermore, since the communication line is structurally stable, the quality of the signal transmitted inside the communication line can be improved.

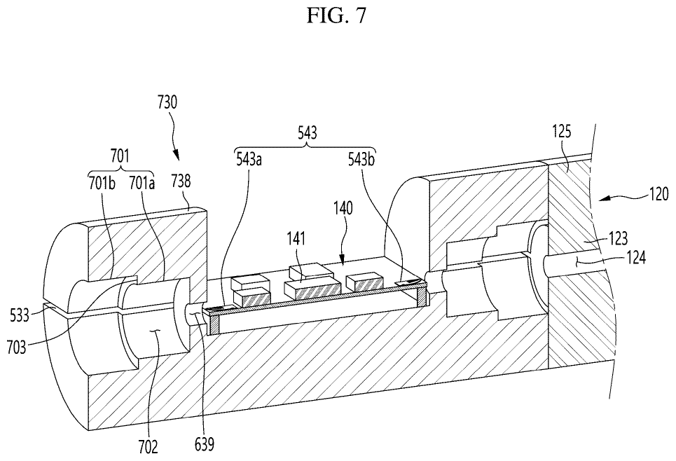

Meanwhile, the signal adjustment unit 530 may include an antenna that receives an electromagnetic wave signal emitted from an end portion of a transmission unit 120a, converts the received electromagnetic wave signal into an electrical signal or converts an adjusted electrical signal into an electromagnetic wave signal, and emits the converted signal toward a transmission unit 120b. Here, the antenna may be of various types. For example, as illustrated in FIG. 5, a Vivaldi antenna 543 may be disposed on a circuit board 140. The number of antennas according to the embodiment of the present disclosure is not limited, and although only one Vivaldi antenna 543 is illustrated in FIG. 5, another Vivaldi antenna 543 may not be visible because it is covered by a sidewall 538 of the signal adjustment unit 530. The signal adjustment unit 530 in which the Vivaldi antenna 543 is disposed will be described below with reference to FIG. 7.

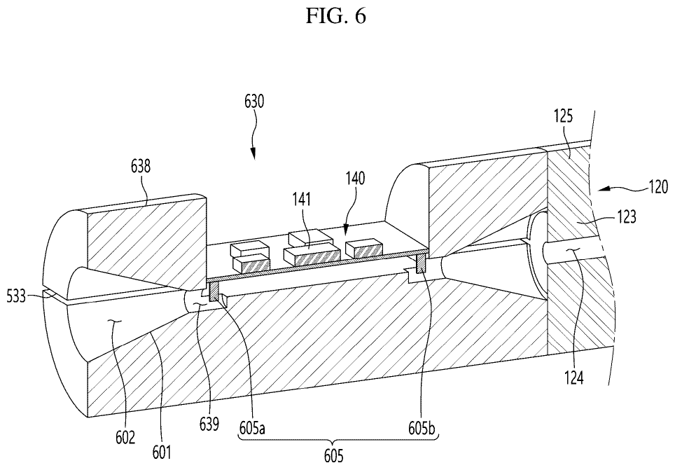

Meanwhile, according to the embodiment of the present disclosure, a signal adjustment unit 630 may further include a guide unit that forms a space in which a signal is guided. This will be described with reference to FIG. 6.

FIG. 6 is a cross-sectional view of a state in which a transmission unit is coupled to one side of a signal adjustment unit including a guide unit forming a space having a frustum shape according to yet another embodiment of the present disclosure. Here, a frustum may be a portion between two parallel planes cutting a cone or pyramid, and in FIG. 6, for example, a guide unit 601 forming a space 602 having a truncated conical shape is disclosed.

Referring to FIG. 6, the guide unit 601 for guiding a signal may be provided on each of both sides of the signal adjustment unit 630. Further, the space 602 formed by the guide unit 601 may have a shape recessed in a longitudinal direction of the signal adjustment unit 630 from one side of the signal adjustment unit 630. Further, as illustrated in FIG. 6, in order to guide a signal emitted from a transmission unit 120 or a signal emitted from the signal adjustment unit 630, the guide unit 601 may be formed in a portion of the signal adjustment unit 630 close to the transmission unit 120.

Further, as illustrated in FIG. 6, the signal adjustment unit 630 may further include a feed unit 605. The feed unit 605 may be electrically connected to a circuit board 140, and may transmit or receive a signal between the circuit board 140 and the transmission unit 120. For example, a first feed unit 605a may receive a signal received from the transmission unit 120 and transmit the received signal to the circuit board 140, and a second feed unit 605b may radiate a signal adjusted in the circuit board 140 toward the transmission unit 120. Meanwhile, as illustrated in FIG. 6, although the feed unit 605 may be located below the circuit board 140, the location of the feed unit 605 is not limited thereto. Further, the feed unit 605 and the space 602 which is formed by the guide unit 601 may communicate through an opening 639.

Further, as illustrated in FIG. 6, a cross-section of the guide unit 601 in a direction perpendicular to the longitudinal direction may become wider as the guide unit 601 approaches the transmission unit 120 so that the directivity and uniformity of an electromagnetic wave signal guided into the space 602 can be improved. That is, a cross-sectional area of the guide unit 601 in the direction perpendicular to the longitudinal direction may increase as the guide unit 601 approaches the transmission unit 120. In this case, the signal reflected from the guide unit 601 may have improved uniformity and directivity. Accordingly, the signal radiated from the transmission unit 120 may reach the feed unit 605 with low loss, and the signal radiated from the feed unit 605 may also reach the transmission unit 120 with low loss.

Meanwhile, according to the embodiment of the present disclosure, at least a portion of an inner surface of the guide unit 601 may be made of a conductor so that the guide unit 601 can reflect the signal without loss. For example, the at least a portion of the inner surface of the guide unit 601 may be plated with a conductor. For another example, a sidewall 638 formed on each of both sides of the signal adjustment unit 630 may be made of a conductor, and accordingly, the inner surface of the guide unit 601 provided inside the sidewall 638 may also be made of a conductor.

Further, as illustrated in FIG. 6, the cross-section of the guide unit 601 in the direction perpendicular to the longitudinal direction of the signal adjustment unit 630 may have a circular shape. In this case, the signal emitted from the transmission unit 120 may be guided more uniformly to the signal adjustment unit 630, and the signal emitted from the signal adjustment unit 630 may be guided more uniformly to the transmission unit 120.

Furthermore, referring to FIG. 6, the cross-section of the guide unit 601 in the direction perpendicular to the longitudinal direction may become wider as the guide unit 601 approaches the transmission unit 120 so that the space 602 formed by the guide unit 601 has a frustum shape. For example, as disclosed in FIG. 6, the space 602 may have a truncated conical shape. The shape of the guide unit 601 may be understood as a tapered shape. Due to the shape of the guide unit 601 described above, the guide unit 601 and the feed unit 605 may perform a function of an antenna that can convert an electromagnetic wave communication signal into an electric signal and transmit or receive the signal.

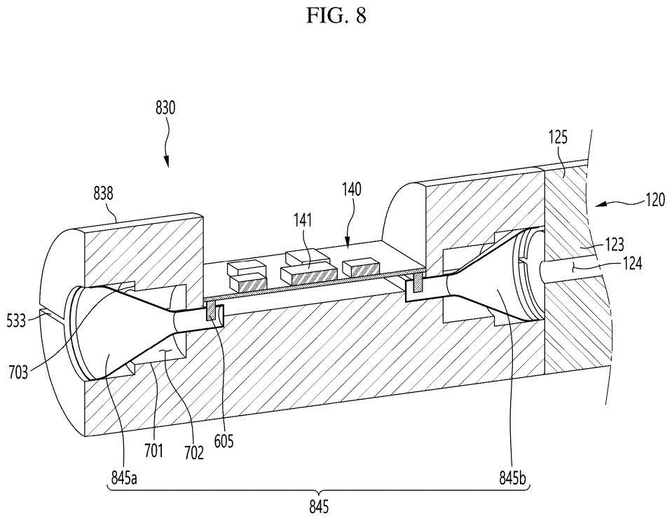

Meanwhile, as described above, the guide unit 601 may reflect the signal and perform the function of the antenna, but signal adjustment units 730 and 830 may include various antennas 543 and 845 as separate components, respectively, and a space 702 formed by a guide unit 701 may be a space for a horn antenna 845 to be mounted therein. Further, a shape of an inner surface of the guide unit 701 is not limited to a tapered shape, and the inner surface of the guide unit 701 may include one or more step portions 703. This will be further described with reference to FIGS. 7 and 8.

FIG. 7 is a cross-sectional view of a state in which a transmission unit is coupled to one side of a signal adjustment unit in which a Vivaldi antenna is disposed according to yet another embodiment of the present disclosure. FIG. 8 is a cross-sectional view of a state in which a transmission unit is coupled to one side of a signal adjustment unit in which a horn antenna is disposed according to yet another embodiment of the present disclosure. Since FIGS. 7 and 8 are cross-sectional views, components disclosed in these drawings may have a shape cut in half.

Referring to FIGS. 5 and 7, each of signal adjustment units 530 and 730 may include one or more Vivaldi antennas 543. The Vivaldi antenna 543 may convert a signal received from a transmission unit 120 into an electrical signal or emit an adjusted signal toward the transmission unit 120, and may be disposed on a circuit board 140.

The Vivaldi antennas 543 disclosed in FIGS. 5 and 7 may be disposed on a board with various transmission methods being used. For example, a microstrip line or a coplanar waveguide (CPWG) may perform a feeding function between a dielectric board and the Vivaldi antenna 543. The Vivaldi antennas 543 may have broadband characteristics and may be easily manufactured because the Vivaldi antennas 543 may be simply formed on a board. The Vivaldi antennas 543 may be formed by being printed on a board, and may also be implemented by being printed in a laminated manner. The shape of the Vivaldi antennas 543 may vary, and is not limited to the shape illustrated in the drawings of the present disclosure.

Meanwhile, in order to prevent a problem in that the signal is lost between the Vivaldi antenna 543 and the transmission unit 120, the Vivaldi antenna 543 may be disposed on a portion of the circuit board 140 closest to the transmission unit 120. For example, as illustrated in FIG. 7, the Vivaldi antennas 543 may be disposed on edge portions of a surface of the circuit board 140.

Referring to FIGS. 5 and 7, the Vivaldi antennas 543 according to the embodiment of the present disclosure may receive a signal from an end portion of the transmission unit 120 or emit an adjusted signal toward the end portion of the transmission unit 120. For example, the Vivaldi antenna 543 may be disposed on the circuit board 140 so that a portion thereof from which the signal is radiated faces the end portion of the transmission unit 120. Here, as illustrated in FIGS. 5 and 7, the Vivaldi antennas 543 may be disposed on edges of the circuit board 140.

Meanwhile, as illustrated in FIG. 7, the guide unit 701 may include a step portion 703. Here, the number of step portions 703 is not limited. For example, the guide unit 701 may include five step portions 703, and the guide unit 701 may have a step shape due to the five step portions 703. Further, a cross-sectional area of each of portions 701a and 701b of the guide unit 701 separated by the step portions 703 in a direction perpendicular to a longitudinal direction of the signal adjustment unit 730 may be constant. That is, the cross-sectional area of the first portion 701a of the guide unit 701 may be constant in the longitudinal direction of the signal adjustment unit 730, and the cross-sectional area of the second portion 701b of the guide unit 701 may also be constant in the longitudinal direction of the signal adjustment unit 730. Here, the longitudinal direction of the signal adjustment unit 730 may be the same as the longitudinal direction of the transmission unit 120, and may be the same as a direction in which a signal is transmitted in the communication line.

Further, among the portions 701a and 701b of the guide unit 701 separated by the step portions 703, the cross-sectional area of the portion 701b close to the transmission unit 120 may be greater than the cross-sectional area of the portion 701a far from the transmission unit 120. That is, the cross-sectional area of the guide unit 701 may be gradually increased from the center of the signal adjustment unit 730 to the transmission unit 120 while passing through the step portion 703. Here, the shapes of the cross-sections of the first portion 701a of the guide unit 701 and the second portion 701b of the guide unit 701 may form concentric circles. According to the above-described embodiments, the directivity and uniformity of the signal guided by the guide unit 701 can be improved.

The guide unit 701 according to the above-described embodiment may be connected to the insertion groove 533. That is, the space 702 formed by the guide unit 701 may communicate with a space outside the signal adjustment unit 730 through the insertion groove 533.

Meanwhile, the space between the Vivaldi antenna 543 and the transmission unit 120 may be blocked, and an opening 639 may be formed between the Vivaldi antenna 543 and the transmission unit 120 so that the Vivaldi antenna 543 and the transmission unit 120 communicate with each other. For example, as illustrated in FIG. 5, the Vivaldi antenna 543 and the transmission unit 120b may be blocked by a sidewall 538 of the signal adjustment unit 530. Here, the sidewall 538 of the signal adjustment unit 530 may be made of a dielectric material. Preferably, the dielectric material of the sidewall 538 may be the same as a dielectric material of a core portion 123. In this case, a signal transmitted through the dielectric material of the core portion 123 may be transmitted to the dielectric material of the sidewall 538 without distortion, and the Vivaldi antenna 543 may receive the signal that has passed through the sidewall 538.

For another example, as illustrated in FIG. 7, the opening 639 is formed in the sidewall 738 so that the Vivaldi antenna 543 and the transmission unit 120 may communicate through the opening 639. Here, the opening 639 may be connected to the guide unit 701 so that the Vivaldi antenna 543 and the space 702 may communicate with each other. In this case, an electromagnetic wave signal radiated from the core portion 123 may be reflected by the guide unit 702, thereby improving directivity, and may be transmitted to the Vivaldi antenna 543b through the opening 639.

Meanwhile, referring to FIG. 8, the signal adjustment unit 830 may include at least one horn antenna 845. The horn antenna 845 may convert an electromagnetic wave signal received from the transmission unit 120 into an electrical signal or emit an adjusted signal toward the transmission unit 120, and may be disposed on the guide unit 701. For example, the horn antenna 845 may be mounted on the guide unit 701 formed in the signal adjustment unit 830, and may guide the electromagnetic wave signal received from the transmission unit 120 to the feed unit 605 to convert the electromagnetic wave signal into an electrical signal, or may guide the electromagnetic wave signal, which is radiated from the feed unit 605 by being adjusted in the circuit board 140, toward one end of the transmission unit 120 to emit the electromagnetic wave signal. Meanwhile, in FIG. 8, although the horn antenna 845 and the feed unit 605 are illustrated as separate components, the feed unit 605 may be a portion of the horn antenna 845.

The horn antenna 845 illustrated in FIG. 8 may have a structure in which a cross-section of a waveguide is gradually widened and electromagnetic wave energy can be radiated and transitioned between the waveguide and a space inside the waveguide. The horn antenna 845 may have an inner surface plated with a metal, or may be made entirely of a metal. With this structure, the horn antenna 845 may impart directivity to the electromagnetic wave signal and enable uniformity to be improved.

Referring to FIG. 8, the space 702 formed by the guide unit 701 may be a space for the horn antenna 845 to be mounted therein. Further, the horn antenna 845 mounted on the guide unit 701 may be in contact with a portion of the guide unit 701. For example, the horn antenna 845 may be in contact with a portion of the guide unit 701 close to the transmission unit 120, or may be in contact with the step portion 703. This structure may be understood as a structure in which the horn antenna 845 is mounted on the guide unit 701 and surrounded and fixed by the sidewall 838. According to the above-described embodiment, the horn antenna 845 may be stably supported by the guide unit 701.

Referring to FIG. 8, the horn antenna 845 may be connected to the circuit board 140 to transmit or receive an electrical signal. Accordingly, the horn antenna 845 may transmit a converted electrical signal to the circuit board 140 or receive an adjusted electrical signal from the circuit board 140.

Meanwhile, as described above, when the one end of the transmission unit 120 is fitted into the insertion groove 533, an opening surface of the horn antenna 845 may face a cross-section of the core portion 123 as disclosed in FIG. 8. For example, a diameter of the core portion 123 and a diameter of the opening surface of the horn antenna 845 may be substantially the same, and when the transmission unit 120 and the signal adjustment unit 830 are coupled, the cross-section of the core portion 123 and the opening surface of the horn antenna 845 may overlap. In this case, a signal radiated from the cross-section of the core portion 123 may not be emitted to the outside because the signal is blocked by the horn antenna 845, and thus may be completely transmitted to the circuit board 140 through the horn antenna 845.

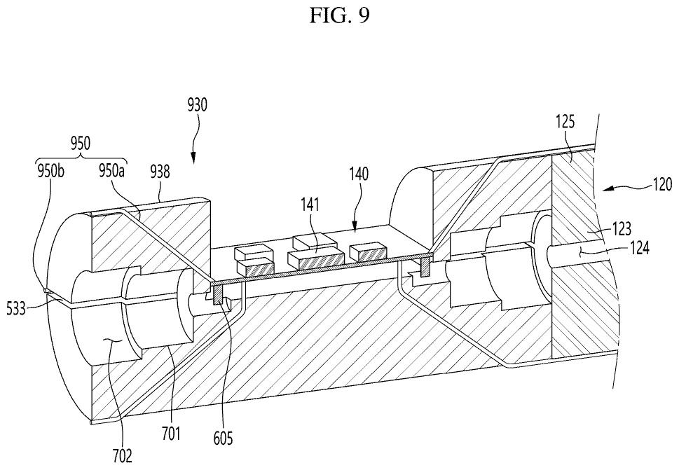

FIG. 9 is a cross-sectional view of a state in which a transmission unit is coupled to one side of a signal adjustment unit connected to a conductor portion according to yet another embodiment of the present disclosure. A guide unit 701 disclosed in FIG. 9 includes a step portion 703 described with reference to FIGS. 7 and 8, but the shape of the guide unit 701 is not limited thereto. For example, the guide unit 701 of FIG. 9 may be replaced with the guide unit 601 forming the space 602 having a frustum shape described with reference to FIG. 6.

Referring to FIGS. 4 and 9, portions of conductor portions 350 and 950 may be disposed adjacent to a distal end portion 129 of a rib 125, and an end portion of the conductor portion 950 may be connected to a circuit board 140. Specifically, the portions of the conductor portions 350 and 950 may be disposed adjacent to the distal end portion 129 of the rib 125, another portions thereof may be disposed inside an insertion groove 533 or inside a sidewall 938 of a signal adjustment unit 930, and end portions thereof may be connected to the circuit board 140. In FIG. 9, although the end portion of the conductor portion 950 is illustrated as being connected to an upper or lower surface of the circuit board 140, the method and form in which the conductor portion 950 is connected to the circuit board 140 is not limited thereto.

Although not illustrated in FIG. 9 for simplicity of description, according to the embodiment of the present disclosure, a terminal (not illustrated) for connection to the conductor portion 950 may be disposed on the circuit board 140. For example, the terminal (not illustrated) may be mounted and disposed on the upper or lower surface of the circuit board 140.

Meanwhile, in FIG. 9, although four conductor portions 950 are illustrated as being disposed on left and right sides of the signal adjustment unit 930, the number of conductor portions 950 is not limited thereto. For example, the conductor portions may be composed of only a conductor portion that supplies power (source) to the signal adjustment unit 930 and a conductor portion that supplies ground.

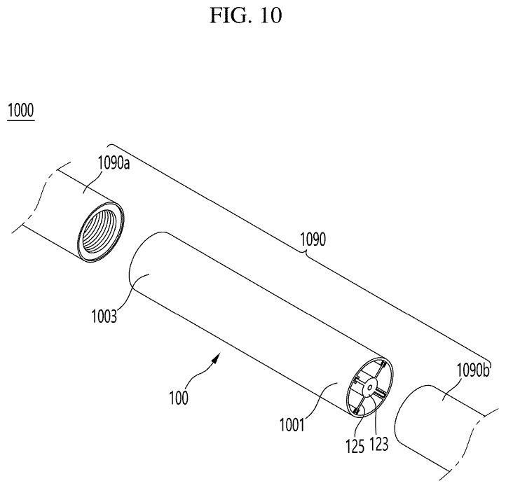

Meanwhile, a communication system 1000 may be constructed using a communication line 100. This will be described with reference to FIG. 10.

FIG. 10 is a view for describing a communication system using a communication line according to an embodiment of the present disclosure. A communication line 100 disclosed in FIG. 10 may be the same as the communication line 100 disclosed in FIG. 1. However, this is only illustrated to describe one embodiment, and a communication line 300 according to various embodiments of the present disclosure may be installed in the communication system 1000. Further, in FIG. 10, although a transmitter 1090 is illustrated as being disposed to be spaced apart from the communication line 100, in some cases, the transmitter 1090 may come into direct contact with the communication line 100.

Referring to FIG. 10, the communication system 1000 may include the communication line 100 and the transmitter 1090 that outputs an electromagnetic wave signal toward the communication line 100. The transmitter 1090 may be a transceiver capable of not only outputting an electromagnetic wave signal but also receiving an electromagnetic wave signal. For example, the transmitter 1090 may be an antenna capable of transmitting or receiving an electromagnetic wave signal. According to the above-described embodiment, the communication system 1000 may transmit an electromagnetic wave signal, which is output from the transmitter 1090, from one end 1001 of the communication line 100 to the other end 1003 or from the other end 1003 to the one end 1001.

Further, the transmitter 1090 according to the embodiment of the present disclosure may be a coupler that has an antenna (not illustrated) therein and is connected to a board (not illustrated). For example, the transmitter 1090 may be mounted on a surface of the board (not illustrated) with an antenna (not illustrated) disposed thereon, or may be coupled to the board (not illustrated) so that the antenna (not illustrated) disposed separately on the board (not illustrated) is located inside the transmitter 1090. Alternatively, the antenna (not illustrated) mounted on the surface of the board (not illustrated) may radiate an electromagnetic wave signal from an outside of the transmitter 1090, and the transmitter 1090 may guide an electromagnetic wave signal to be radiated toward the communication line 100. Meanwhile, the transmitter 1090 may have a cylindrical shape with a waveguide formed therein as illustrated in FIG. 10, but the structure and shape of the transmitter 1090 are not limited thereto.

Further, although not illustrated in FIG. 10, conductors (not illustrated) electrically connected to the conductor portions 350 and 950 described with reference to FIGS. 3, 4, and 9 may be disposed in the transmitter 1090. The conductors (not illustrated) disposed in the transmitter 1090 may transmit a signal transmitted from the board (not illustrated) to the conductor portions 350 and 950.

Meanwhile, referring to FIG. 10, as described above, the communication line 100 may be installed such that a direction in which ribs 125 extend from a core portion 123 is misaligned with a horizontal polarization direction or a vertical polarization direction of an electromagnetic wave signal so that the electromagnetic wave signal does not leak to an outside of the communication line 100. Here, the electromagnetic wave is composed of an electric field (E-field) and a magnetic field (H-field) that oscillate perpendicularly to each other, and the horizontal polarization direction of the electromagnetic wave signal may be one of an electric field oscillation direction or a magnetic field oscillation direction, and the vertical polarization direction may be the other.

For example, as illustrated in FIG. 10, the communication line 100 may be disposed in a longitudinal direction with being rotated 45° around a central axis. In this case, the extension direction of the rib 125 may be a direction forming a character X, and the horizontal polarization direction or the vertical polarization direction of the electromagnetic wave signal radiated from the transmitter 1090 may be a direction forming a cross (+). That is, the extension direction of the rib 125 may form a 45° angle with the horizontal polarization direction or the vertical polarization direction of the electromagnetic wave signal. In this case, since the extension direction of the rib 125 and the polarization direction of the electromagnetic wave signal can be maximally misaligned, the phenomenon in which the electromagnetic wave signal transmitted through the core portion 123 leaks out of the communication line 100 can be minimized. Accordingly, a signal attenuation degree according to a length of the communication line 100 can also be significantly reduced.

According to one of the solutions of the present disclosure, a communication line can prevent signal loss or noise intensity from increasing even when its length increases.

According to one of the solutions of the present disclosure, a communication line can change or control a signal transmitted inside the communication line.

According to one of the solutions of the present disclosure, a communication line can output or receive various signals and thereby being connected to various boards.

According to one of the solutions of the present disclosure, a communication line can be easily assembled and parts used for assembly can be changed in various ways.

According to one of the solutions of the present disclosure, a communication line can be easily bent, and easily connect devices to each other even in a narrow or complex space.

The effects obtainable in the present disclosure are not limited to the above-described effects and other effects that are not described may be clearly understood by those skilled in the art from the above detailed descriptions.

While embodiments of the present disclosure have been described in more detail with reference to the accompanying drawings, the present disclosure is not necessarily limited to these embodiments, and various modifications may be made in the present disclosure without departing from the spirit and scope of the present disclosure. Accordingly, the embodiments disclosed in the present disclosure are not intended to limit the technical idea of the present disclosure but to explain it, and the scope of the technical idea of the present disclosure is not limited by these embodiments. Therefore, it should be understood that the embodiments described above are exemplary in all respects and not restrictive. The scope of the present disclosure should be interpreted by the appended claims and encompasses all modifications and equivalents that fall within the scope of the appended claims.

What is claimed is:

1. A communication line comprising:
a shielding portion that has a hollow pipe shape and extends in a longitudinal direction;
at least one transmission unit that is disposed inside the shielding portion and transmits a signal from one end thereof to the other end; and
a signal adjustment unit that is disposed inside the shielding portion and adjusts the signal received from the transmission unit.

2. The communication line of claim 1, wherein the transmission unit includes a core portion that extends in the longitudinal direction to transmit an electromagnetic wave signal received at the one end to the other end through a dielectric material.

3. The communication line of claim 2, wherein the transmission unit includes a first transmission unit and a second transmission unit, and
the signal adjustment unit is disposed between the first transmission unit and the second transmission unit and adjusts a signal received from the first transmission unit and transmits the adjusted signal to the second transmission unit.

4. The communication line of claim 2, wherein the signal adjustment unit includes at least one of:
an amplifier that amplifies the received signal;
a filter that removes noise from the received signal; and
a frequency converter that changes a frequency of the received signal.

5. The communication line of claim 4, wherein the signal adjustment unit further includes a circuit board, and
at least one of the amplifier, the filter, and the frequency converter is mounted on the circuit board.

6. The communication line of claim 4, wherein the signal adjustment unit further includes a guide unit that forms a space in which a signal is guided,
the space formed by the guide unit has a shape recessed in a longitudinal direction of the signal adjustment unit from one side of the signal adjustment unit, and
a cross-section of the guide unit in a direction perpendicular to the longitudinal direction of the signal adjustment unit has a circular shape.

7. The communication line of claim 6, wherein, in order for the space formed by the guide unit to have a frustum shape, a cross-sectional area of the guide unit in the direction perpendicular to the longitudinal direction increases as the guide unit approaches the transmission unit, and
at least a portion of an inner surface of the guide unit is made of a conductor to reflect signals.

8. The communication line of claim 6, wherein the guide unit includes at least one step portion,
a cross-sectional area of each of portions of the guide unit separated by the step portion unit in the direction perpendicular to the longitudinal direction of the signal adjustment is constant, and
among the portions of the guide unit separated by the step portion, a cross-sectional area of a portion closer to the transmission unit is greater than a cross-sectional area of a portion farther from the transmission unit.

9. The communication line of claim 6, wherein the signal adjustment unit includes at least one horn antenna which converts a signal received from the transmission unit into an electrical signal or emits an adjusted signal toward the transmission unit and which is disposed on the guide unit.

10. The communication line of claim 5, wherein the signal adjustment unit includes at least one Vivaldi antenna which converts a signal received from the transmission unit into an electrical signal or emits an adjusted signal toward the transmission unit and which is disposed on the circuit board.

11. The communication line of claim 2, wherein the transmission unit is inserted into the shielding portion in the longitudinal direction and disposed in the shielding portion, and
one side end surfaces of the transmission unit and the signal adjustment unit face each other.

12. The communication line of claim 11, wherein the transmission unit includes at least one rib formed to extend from an outer surface of the core portion,
at least one rib fixing unit formed to extend in the longitudinal direction of the shielding portion is formed on an inner surface of the shielding portion, and
the transmission unit is disposed while being slid so that the rib corresponds to the rib fixing unit.

13. The communication line of claim 12, wherein the rib fixing unit includes a first fixing portion and a second fixing portion that are formed to extend in the longitudinal direction of the shielding portion and to protrude from the inner surface of the shielding portion, and
the rib is disposed in a space between the first fixing portion and the second fixing portion.

14. The communication line of claim 13, further comprising at least one conductor portion configured to transmit a signal different from the signal transmitted from the transmission unit,
wherein at least a portion of the conductor portion is disposed:
between the first fixing portion and the second fixing portion; and
between a distal end portion of the rib and the inner surface of the shielding portion.

15. The communication line of claim 14, wherein an end portion of the conductor portion is connected to the signal adjustment unit, and
the conductor portion includes at least one of:
a conductor portion that transmits or receives a signal to or from the signal adjustment unit; and
a conductor portion that supplies power to the signal adjustment unit.

16. The communication line of claim 12, wherein the rib includes a first rib and a second rib that are formed to be spaced apart from each other in a longitudinal direction of the core portion on the outer surface of the core portion.

17. The communication line of claim 11, wherein an insertion groove having a shape corresponding to a shape of the one side end surface of the transmission unit is formed in an end surface of the signal adjustment unit, and
one end of the transmission unit is fitted into the insertion groove.

18. The communication line of claim 11, wherein the core portion has a hollow pipe shape,
an insertion protrusion that protrudes to correspond to a shape of a hole inside the core portion is formed in the end surface of the signal adjustment unit, and
the insertion protrusion is inserted into the hole inside the core portion.
